(19) United States
(12) Patent Application Publication
(10) Pub. No.: US 2026/0205941 A1
(43) Pub. Date: Jul. 16, 2026

(54) SECONDARY ACCESS NODE SLEEP MODE MANAGEMENT IN WIRELESS COMMUNICATION NETWORKS

(71) Applicant: T-MOBILE INNOVATIONS LLC, Overland Park, KS (US)

(72) Inventor: Jahangir Alam Mollah, Sammamish, WA (US)

(21) Appl. No.: 19/016,969

(22) Filed: Jan. 10, 2025

(51) Int. Cl. H04W 52/02; H04W 76/15; H04W 76/20; H04W 76/30

(52) U.S. Cl. CPC H04W 52/0206; H04W 76/15; H04W 76/20; H04W 76/30

(57) ABSTRACT

Various embodiments include a system that comprises a primary access node and a secondary access node. The primary access node serves a user device and directs the secondary access node to serve the user device. The secondary access node enters sleep mode. The secondary access node ceases providing service while in sleep mode. The secondary access node notifies the primary access node that it is entering sleep mode. The primary access node wirelessly transfers a remove command to a wireless user device that directs the wireless user device to terminate its connection with the secondary access node. The secondary access node exits sleep mode. The secondary access node notifies the primary access node that the secondary access node is exiting the sleep mode. The primary access node wirelessly transfers an add command to the wireless user device that directs the wireless user device to connect to the secondary access node.

### TECHNICAL FIELD

Various embodiments of the present technology relate to wireless connectivity, and more specifically, to managing secondary access node sleep mode.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Carrier aggregation is a type of wireless communication to increase the amount of data exchanged between wireless user devices and RANs. Carrier aggregation utilizes a primary cell and one or more secondary cells. The primary and secondary cells correspond to different radio frequency bands. Radio frequency bands are divided into multiple frequency blocks referred to as component carriers. The component carriers are used to carry the data and signaling between the RAN and user device. In carrier aggregation, multiple component carriers from the primary and secondary cell(s) are grouped to carry data and signaling between the RAN and user device. The grouped component carriers may be from the same radio band or different radio bands. When from the same band, the component carriers may be contiguous (e.g., adjacent resource blocks) or non-contiguous (e.g., non-adjacent resource blocks). The primary cell is provided by a primary access node and the secondary cells are provided by secondary access nodes. The primary access node and secondary access node(s) are referred to as an Evolved Universal Terrestrial Radio Access Network Dual Connectivity (EN-DC) access node.

The secondary access nodes may enter sleep mode during scheduled maintenance periods, at specified times or day or days of the week, to save energy, in response to low network usage, and the like. When in sleep mode, the secondary access node notifies the primary access node. The primary access node directs the user device to detach from the secondary access node. The user device then blacklists the secondary access node to prevent the user device from attempting to connect to the secondary access node while it is in sleep mode. When the secondary access node comes back online, it notifies the primary access node that it is available and begins broadcasting reference signals to indicate its availability to user devices. However, user devices that previously blacklisted the secondary access node will not attempt to connect to the secondary access node even though it has exited sleep mode. This reduces network throughput and degrades the overall user experience.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for Radio Access Network (RAN) connectivity. Some embodiments comprise a method. The method comprises serving, by a primary access node, a wireless user device and directing a secondary access node to serve the wireless user device. The method further comprises entering, by the secondary access node, sleep mode. The secondary access node ceases providing wireless service while in sleep mode. The method further comprises notifying, by the secondary access node, the primary access node that the secondary access node is entering sleep mode. The method further comprises wirelessly transferring, by the primary access node, a remove command to the wireless user device that directs the wireless user device to terminate its connection with the secondary access node. The method further comprises exiting, by the secondary access node, sleep mode. The method further comprises notifying, by the secondary access node, the primary access node that the secondary access node is exiting sleep mode. The method further comprises wirelessly transferring, by the primary access node, an add command to the wireless user device that directs the wireless user device to connect to the secondary access node.

Some embodiments comprise a system. The system comprises a primary access node and a secondary access node. The primary access node serves a wireless user device and directs the secondary access node to serve the wireless user device. The secondary access node enters sleep mode. The secondary access node ceases providing wireless service while in sleep mode. The secondary access node notifies the primary access node that it is entering sleep mode. The primary access node wirelessly transfers a remove command to the wireless user device that directs the wireless user device to terminate its connection with the secondary access node. The secondary access node exits sleep mode. The secondary access node notifies the primary access node that the secondary access node is exiting sleep mode. The primary access node wirelessly transfers an add command to the wireless user device that directs the wireless user device to connect to the secondary access node.

Some embodiments comprise one or more non-transitory computer readable storage media having program instructions stored thereon. When executed by a computing system, the program instructions direct the computing system to perform operations. The operations comprise controlling a radio to serve a wireless user device. The operations further comprise directing a secondary access node to serve the wireless user device. The operations further comprise receiving a sleep mode enter indication generated by the secondary access node. The secondary access node ceases providing wireless service while in sleep mode. The operations further comprise generating a remove command that directs the wireless user device to terminate its connection with the secondary access node. The operations further comprise directing the radio to wirelessly transfer the remove command to the wireless user device. The operations further comprise receiving a sleep mode exit indication generated by the secondary access node. The operations further comprise generating an add command that directs the wireless user device to connect to the secondary access node. The operations further comprise directing the radio to wirelessly transfer the add command to the wireless user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network that manages secondary access node sleep mode.

FIG. 2 illustrates a first example operation of the communication network to manage secondary access node sleep mode.

FIG. 3 illustrates a second example operation of the communication network to manage secondary access node sleep mode.

FIG. 4 illustrates a third example operation of the communication network to manage secondary access node sleep mode.

FIG. 5 illustrates an example of a Fifth Generation (5G)/Long Term Evolution (LTE) communication network that manages secondary access node sleep mode.

FIG. 6 illustrates an example of a User Equipment (UE) in the 5G/LTE communication network that manages secondary access node sleep mode.

FIG. 7 illustrates an example of an Evolved Universal Terrestrial Radio Access Network Dual Connectivity (EN-DC) access node in the 5G/LTE communication network that manages secondary access node sleep mode.

FIG. 8 further illustrates the example of the EN-DC access node in the 5G/LTE communication network that manages secondary access node sleep mode.

FIG. 9 illustrates an example of an LTE data center in the 5G/LTE communication network that manages secondary access node sleep mode.

FIG. 10 illustrates an example operation of the 5G/LTE communication to manage secondary access node sleep mode.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In conventional wireless communication networks, primary access nodes serve user devices over primary cells and control secondary access nodes to serve wireless user devices over secondary cells in a process referred to as carrier aggregation. Carrier aggregation is used to increase network throughput and improve the user experience. The secondary access nodes periodically come offline for maintenance, to save energy, in response to low network usage, and the like. This offline state is referred to as sleep mode. When a secondary access node enters sleep mode, the primary access node notifies user devices attached to secondary access node. These devices then blacklist the secondary access node to prevent the devices from attempting to attach to an unavailable access node which helps to converse device power and computing resources. When the secondary access node comes back online and exits sleep mode, it begins broadcasting reference signals to indicate its availability to the user devices. However, user devices that have blacklisted this node ignore these reference signals and will not attach to the secondary access node even though it is available for use. This negatively impacts network throughput.

To overcome the above-described problems in conventional wireless communication networks, various embodiments of the present technology relate to managing secondary access node sleep mode. In some examples, a primary access node serves user devices and controls a secondary access node to serve the user devices. The secondary access node enters sleep mode and notifies the primary access node. The primary access node directs user devices attached to the node to detach. Subsequently, the secondary access node exits sleep mode and notifies the primary access node. The primary access node then directs the user devices to reattach to the secondary access node. Directing user devices to reattach to secondary access nodes that have exited sleep mode inhibits the user devices from blacklisting available secondary access nodes which improves network resource usage, increases network throughput, and improves the user experience. Now referring to the Figures.

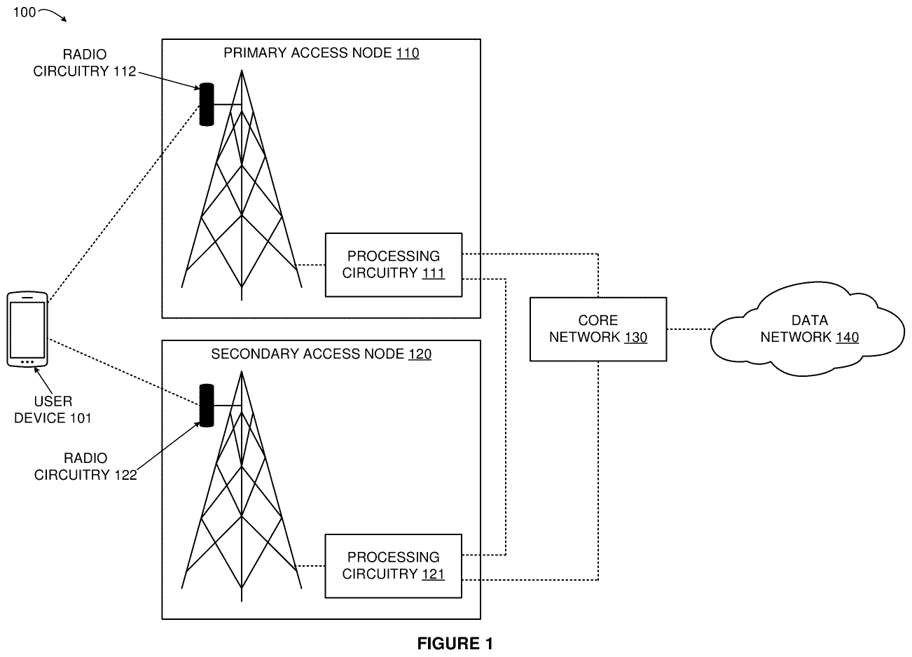

FIG. 1 illustrates communication network 100 to manage secondary access node sleep mode. Communication network 100 provides services like media-streaming, media-broadcasting, internet-access, voice/video calling, text messaging, online gaming, social media, machine communications, or some other wireless communications product. Communication network 100 comprises user device 101, primary access node 110, secondary access node 120 core network 130, and data network 140. Primary access node 110 comprises processing circuitry 111 and radio circuitry 112. Secondary access node 120 comprises processing circuitry 121 and radio circuitry 122. In other examples, communication network 100 may comprise additional or different elements than those illustrated in FIG. 1.

Various examples of network operation and configuration are described herein. In some examples, user device 101 measures a pilot signal broadcast by primary access node 110 and responsively attaches to primary access node 110. Primary access node 110 exchanges signaling with user device 101 to establish wireless data and signaling links. User device 101 communicates with core network 130 over primary access node 110 to request wireless data services over primary access node 110. Core network 130 approves the service request and directs primary access node 110 to serve user device 101. User device 101 wirelessly exchanges user data with data network 140 over primary access node 110 and core network 130. User device 101 measures a pilot signal broadcast secondary access node 120 and wirelessly indicates a dual connectivity capability to primary access node 110. Primary access node 110 directs secondary access node 120 to serve user device 101. Primary access node 110 directs user device 101 to attach to secondary access node 120. User device 101 attaches to secondary access node 120 in response to the direction from primary access node 110. Primary access node 110 receives additional user data from core network 130. Primary access node 110 routes a portion of this user data to secondary access node 120. Primary access node 110 and secondary access node 120 wirelessly deliver the user data to user device 101. Serving a user device over multiple cells (e.g., nodes 110 and 120) is referred to as carrier aggregation.

Secondary access node 120 enters sleep mode. During sleep mode, secondary access node 120 ceases providing wireless services to user devices. Secondary access node 120 may enter sleep mode based on a schedule (e.g., time-of-day, day-of-week, a maintenance period, etc.) or in response to threshold conditions (e.g., a low-usage period, energy saving period, etc.). Secondary access node 120 notifies primary access node 110 that it is entering sleep mode. In response, primary access node 110 wirelessly transfers a remove command to user device 101. The remove command directs user device 101 to terminate its connection with secondary access node 120. User device 101 detaches from secondary access node 120 and blacklists secondary access node 120 for wireless connectivity. User device 101 will not attempt to attach to secondary access node 120 when secondary access node 120 is blacklisted. Primary access node 110 continues exchanging user data with user device 101.

Secondary access node 120 exits sleep mode. For example, secondary access node 120 may detect that the sleep mode trigger conditions (e.g., time-of-day, day-of-week, a maintenance period, low-usage period, energy saving period, etc.) are no longer present and in response, determine to exit sleep mode. Secondary access node 120 notifies primary access node 110 that it is exiting sleep mode. In response, primary access node 110 wirelessly transfers an add command to user device 101. The add command directs user device 101 to connect to secondary access node 120. User device 101 attaches to secondary access node 110 and removes secondary access node 120 from the blacklist. Primary access node 110 receives additional user data from core network 130. Primary access node 110 routes a portion of the additional user data to secondary access node 120. Primary access node 110 and secondary access node 120 deliver the additional user data to user device 101.

Advantageously, primary access node 110 effectively manages the sleep mode of secondary access node 120 by directing user devices to reattach when secondary access node 120 exits sleep mode. The efficiently inhibits user devices from blacklisting available secondary access nodes thereby increasing network throughput, improving network resource usage, and improving the overall user experience.

User device 101 may comprise a vehicle, drone, robot, computer, phone, sensor, or another type of data appliance with wireless and/or wireline communication circuitry. User device 101, primary access node 110, and secondary access node 120 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although primary access node 110 and secondary access node 120 are illustrated as comprising towers, primary access node 110 and secondary access node 120 may comprise other types of mounting structures (e.g., a building), or no mounting structure at all. Primary access node 110 and secondary access node 120 may comprise a Sixth Generation (6G) Radio Access Network (RAN), Fifth Generation (5G) RAN, LTE RAN, Evolved Universal Terrestrial Radio Access Network Dual Connectivity (EN-DC) access node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Primary access node 110 and secondary access node 120 may be co-located (e.g., at a single base station) or may be geographically distributed. Primary access node 110 and secondary access node 120 exchange network signaling and user data with network functions clustered together into core network 130. Primary access node 110 and secondary access node 120 are connected to core network 130 over one or more backhaul data links. Primary access node 110, secondary access node 120, and core network 130 may communicate via edge networks like internet backbone providers, edge computing systems, or another type of edge system to provide the backhaul data and signaling links between primary access node 110, secondary access node 120, and core network 130. While illustrated as terrestrial based access nodes, primary access node 110 and/or secondary access node 120 may comprise non-terrestrial (e.g., space-based satellite) access nodes.

Primary access node 110 and/or secondary access node 120 may comprise Radio Units (RUs), Distributed Units (DUs) and Centralized Units (CUs). For example, processing circuitry 111 may be representative of a DU and a CU while radio circuitry 112 may be representative of an RU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 130. Alternatively, primary access node 110 and/or secondary access node 120 may comprise RUs and Baseband Units (BBUs). For example, processing circuitry 121 may be representative of a BBU while radio circuitry 122 may be representative of an RU. The BBUs are usually nearby network computers. The BBUs are coupled to network functions in core network 130 and handle network layers like RRC, SDAP, PDCP, RLC, MAC, and PHY. While processing circuitry 111 and processing circuitry 121 are illustrated as separate, it should be appreciated that processing circuitry 111 and processing circuitry 121 may comprise a single computing device. For example, processing circuitry 111 and processing circuitry 121 may comprise a single BBU while radio circuitry 112 and radio circuitry 122 may each comprise an RU connected to the single BBU that provide the primary and secondary cells to user device 101 (i.e., primary access node 110 and secondary access node 120 may share a BBU and have separate RUs).

Core network 130 is representative of computing systems that provide wireless data services to user device 101 over primary access node 110. Exemplary computing systems comprise Network Function Virtualization Infrastructure (NFVI) systems, data centers, server farms, cloud computing networks, hybrid cloud networks, and the like. Core network 130 may comprise a 3GPP core network architecture like Sixth Generation Core (6GC), Fifth Generation Core (5GC), Evolved Packet Core (EPC), and/or another type of 3GPP core network architecture. Primary access node 110, core network 130, and data network 140 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 130 store and execute the network functions/entities to form a control plane and a user plane. Exemplary control plane network functions include Access and Mobility Management Function (AMF), Session Management Function (SMF), Unified Data Management (UDM), Policy Control Function (PCF), Mobility Management Entity (MME), Policy and Rules Charging Function (PCRF), Home Subscriber Server (HSS), and the like. Exemplary user plane network functions include User Plane Functions (UPF), Packet Gateway (PGW), Serving Gateway (SGW), and the like.

Data network 140 comprises an Application Server (AS) that hosts applications (e.g., media streaming applications, social media applications, IoT applications, online gaming applications, etc.) for user device 101. Data network 140 may be representative of a public data network (e.g., the Internet) or a private data network (e.g., an enterprise network). Core network 130 and data network 140 may communicate via links provided by internet backbone providers, edge computing services, and/or other communication services that provide the data links between core network 130 and data network 140.

User device 101, primary access node 110, and secondary access node 120 comprise antennas, amplifiers, filters, modulation, analog/digital interfaces, microprocessors, software, memories, transceivers, bus circuitry, and the like. User device 101, primary access node 110, secondary access node 120, core network 130, and data network 140 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

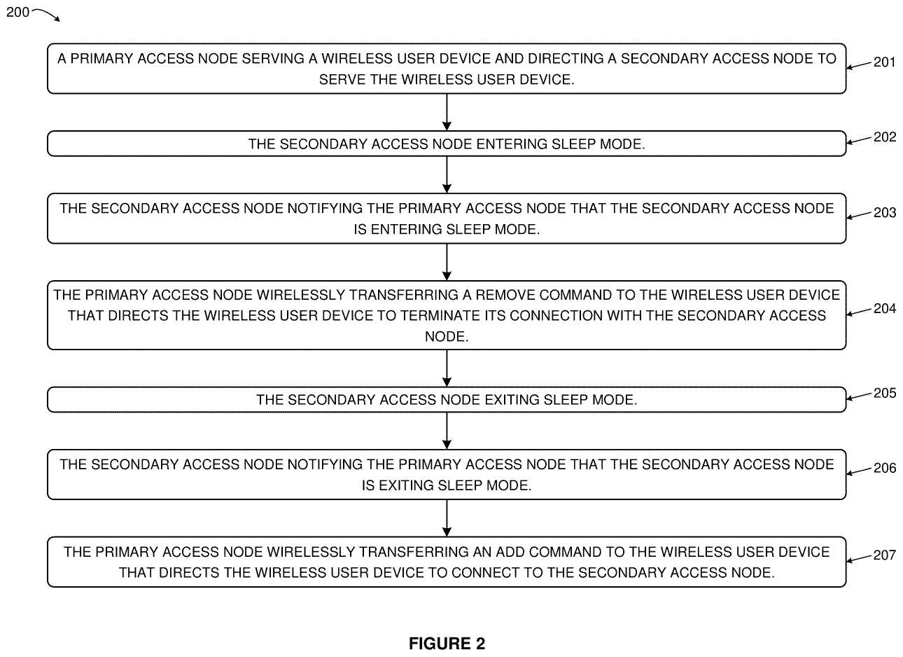

FIG. 2 illustrates process 200. Process 200 comprises an exemplary operation of communication network 100 to manage secondary access node sleep mode. Process 200 may vary in other examples. The operations of process 200 comprise a primary access node serving a wireless user device and directing a secondary access node to serve the wireless user device (step 201). The operations further comprise the secondary access node entering sleep mode (step 202). The secondary access node stops providing wireless service when in sleep mode. The operations further comprise the secondary access node notifying the primary access node that the secondary access node is entering sleep mode (step 203). The operations further comprise the primary access node wirelessly transferring a remove command to the wireless user device that directs the wireless user device to terminate its connection with the secondary access node (step 204). The operations further comprise the secondary access node exiting sleep mode (step 205). The operations further comprise the secondary access node notifying the primary access node that the secondary access node is exiting sleep mode (step 206). The operations further comprise the primary access node wirelessly transferring an add command to the wireless user device that directs the wireless user device to connect to the secondary access node (step 207).

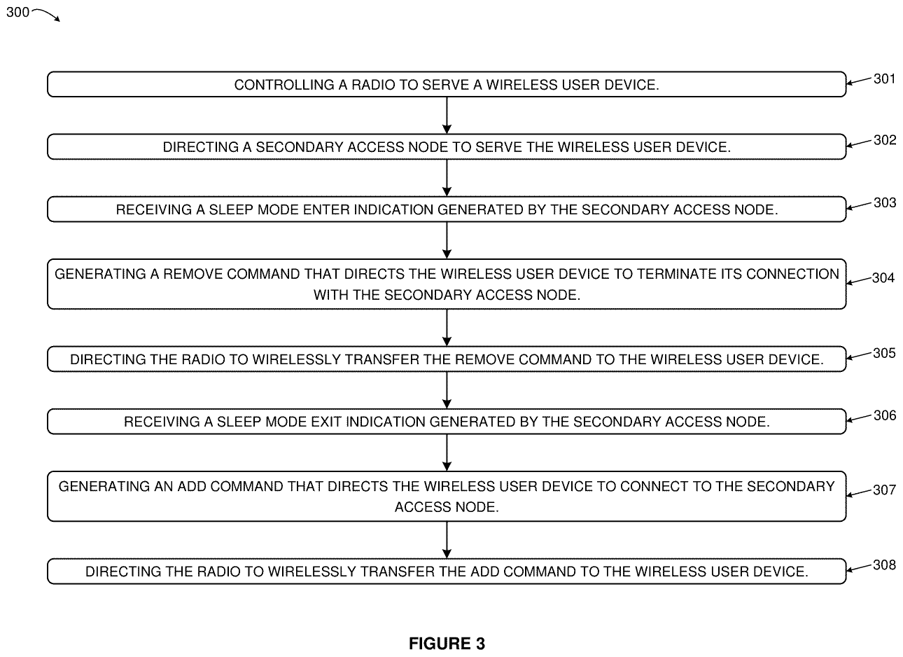

FIG. 3 illustrates process 300. Process 300 comprises an exemplary operation of communication network 100 to manage secondary access node sleep mode. Process 300 comprises an example of process 200 illustrated in FIG. 2, however process 200 may differ. Process 300 may vary in other examples. The operations of process 300 comprise controlling a radio to serve a wireless user device (step 301). The operations further comprise directing a secondary access node to serve the wireless user device (step 302). The operations further comprise receiving a sleep mode enter indication generated by the secondary access node (step 303). The secondary access node stops providing wireless service when in sleep mode. The operations further comprise generating a remove command that directs the wireless user device to terminate its connection with the secondary access node (step 304). The operations further comprise directing the radio to wirelessly transfer the remove command to the wireless user device (step 305). The operations further comprise receiving a sleep mode exit indication generated by the secondary access node (step 306). The operations further comprise generating an add command that directs the wireless user device to connect to the secondary access node (step 307). The operations further comprise directing the radio to wirelessly transfer the add command to the wireless user device (step 308).

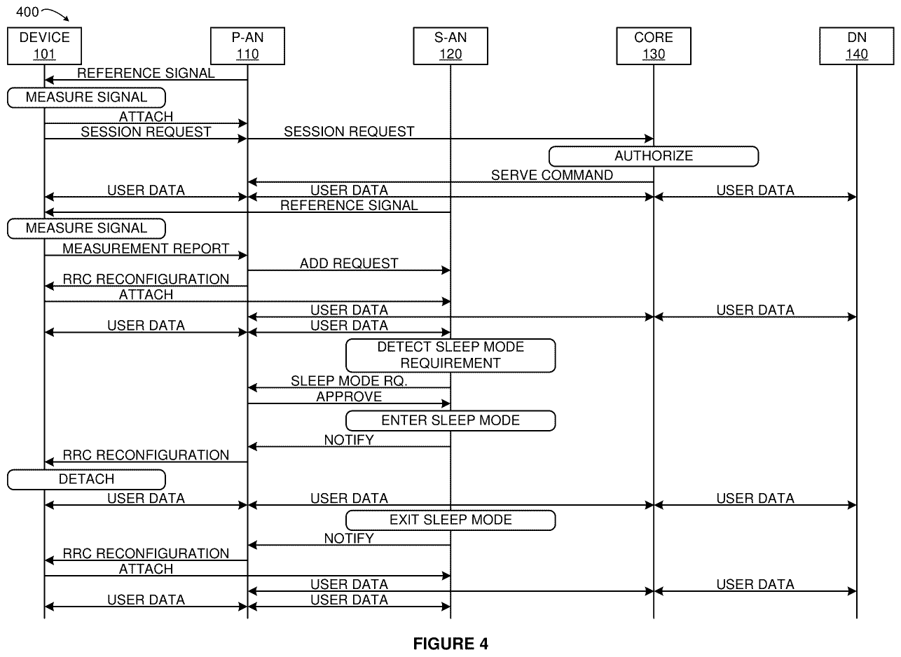

FIG. 4 illustrates process 400. Process 400 comprises an exemplary operation of communication network 100 to manage secondary access node sleep mode. Process 400 comprises an example of process 200 illustrated in FIG. 2 and process 300 illustrated in FIG. 3, however processes 200 and 300 may differ. Process 400 may vary in other examples. In some examples, radio circuitry 112 in primary access node (P-AN) 110 broadcasts reference signals. The reference signals include information which is used by user devices to initiate communications with primary access node 110. User device 101 receives the reference signals and measures signal strength of the reference signals. When the signal strength of the reference signals exceeds quality and/or strength thresholds (e.g., Received Signal Received Power (RSRP) thresholds, Received Signal Received Quality (RSRQ) thresholds, etc.), user device 101 decides to attach to primary access node 110.

User device 101 transfers attachment signaling to processing circuitry (PC) 111 over radio circuitry 112 based on the reference signal to attach to primary access node 110. For example, user device 101 may undergo a random access process with processing circuitry 111 over radio circuitry 112 to attach to primary access node 110. In response to connection setup, user device 101 transfers a session request to core network 130 over primary access node 110. Core network 130 accesses a subscriber profile for user device 101 to authorize the session. Responsive to session authorization, core network 130 directs processing circuitry 111 in primary access node 110 to serve user device 101. For example, core network 130 may indicate service parameters like maximum bitrate, QoS, throughput, latency, and the like for user device 101's session. Processing circuitry 111 transfers an RRC reconfiguration message to user device 101 to setup the session connection and to direct user device 101 to begin the session. User device 101 exchanges user data with processing circuitry 111 over radio circuitry 112 in primary access node 110. Processing circuitry 111 exchanges the user data with core network 130. Core network 130 exchanges the user data with data network (DN) 140.

Contemporaneously, radio circuitry 122 in secondary access node (S-AN) 120 broadcasts reference signals. User device 101 measures the reference signal from secondary access node 120 and decides to attach to secondary access node 120. User device 101 generates a measurement report that includes the measured signal strength (e.g., RSRP, RSRQ, etc.) for secondary access node 120 and transfers the measurement report to processing circuitry 111 in primary access node 110 over radio circuitry 112. User device 101 typically also indicates it's capability to use the Radio Access Technology (RAT) type of secondary access node 120 to primary access node 110. Processing circuitry 111 compares the throughput requirement of user device 101's session to a throughput threshold and compares the reported signal strength to a signal strength threshold to determine if a secondary cell is warranted. When both thresholds are exceeded, processing circuitry 111 transfers an addition request to processing circuitry 121 in secondary access node 120 (e.g., over X2 links that couple access nodes 110 and 120). Processing circuitry 121 in secondary access node 120 acknowledges the request and processing circuitry 111 in primary access node 110 transfers an RRC reconfiguration message to user device 101 over radio circuitry 112 to setup the connection between user device 101 and secondary access node 120.

User device 101 attaches to secondary access node 120 based on the RRC reconfiguration message. Core network 130 exchanges additional user data with data network 140 for the session. Core network 130 exchanges the additional user data with processing circuitry 111 in primary access node 110. Processing circuitry 111 exchanges a portion of the user data with processing circuitry 121 in secondary access node 120 and exchanges the remining portion of the user data with user device 101 over radio circuitry 112. Processing circuitry 121 receives its portion of the user data and exchanges its portion of the user data with user device 101 over radio circuitry 122.

During user device 101's data session, processing circuitry 121 detects a sleep mode requirement. Exemplary sleep mode requirements include time periods, low-usage periods, maintenance periods, energy saving periods, and the like. For example, network usage may decline during the night and network operators may load a sleep schedule to secondary access node 120 that deactivates secondary access node 120 from 11:00 PM to 5:00 AM each night which reduces network energy usage. Processing circuitry 121 may compare the current time to the sleep schedule to detect the sleep mode requirement. Processing circuitry 121 transfers a sleep mode request (RQ.) to processing circuitry 111 in primary access node 110. Processing circuitry 111 approves the request and transfers a sleep mode authorization to processing circuitry 121 in secondary access node 120. In response to the sleep mode authorization, processing circuitry 121 deactivates radio circuitry 122 to cause secondary access node 120 to enter sleep mode. Processing circuitry 121 notifies processing circuitry 111 that secondary access node 120 is in sleep mode and stops exchanging user data for the data session. In response, processing circuitry 111 transfers an RRC reconfiguration message to user device 101 that directs user device to detach from secondary access node 120. User device 101 detaches from and blacklists secondary access node 120 to prevent user device 101 from attempting to attach to secondary access node 120 during the sleep cycle. User device 101, primary access node 110, core network 130, and data network 140 continue exchanging user data for the session.

Subsequently, processing circuitry 121 in secondary access node 120 detects that the sleep mode requirement is no longer present. For example, processing circuitry 121 may compare the current time to a sleep schedule and determine the sleep schedule is no longer in place. In response, processing circuitry 121 activates radio circuitry 122 to cause secondary access node 120 to exit sleep mode. Processing circuitry 121 notifies processing circuitry 111 in primary access node 110 that secondary access node 120 is no longer in sleep mode. In response, processing circuitry 111 transfers an RRC reconfiguration message to user device 101 over radio circuitry 112 that directs user device 101 to reattach to secondary access node 120. User device 101 reattaches to secondary access node 120 and removes secondary access node 120 from user device 101's blacklist. Secondary access node 120 resumes exchanging user data for the session with user device 101 and primary access node 110.

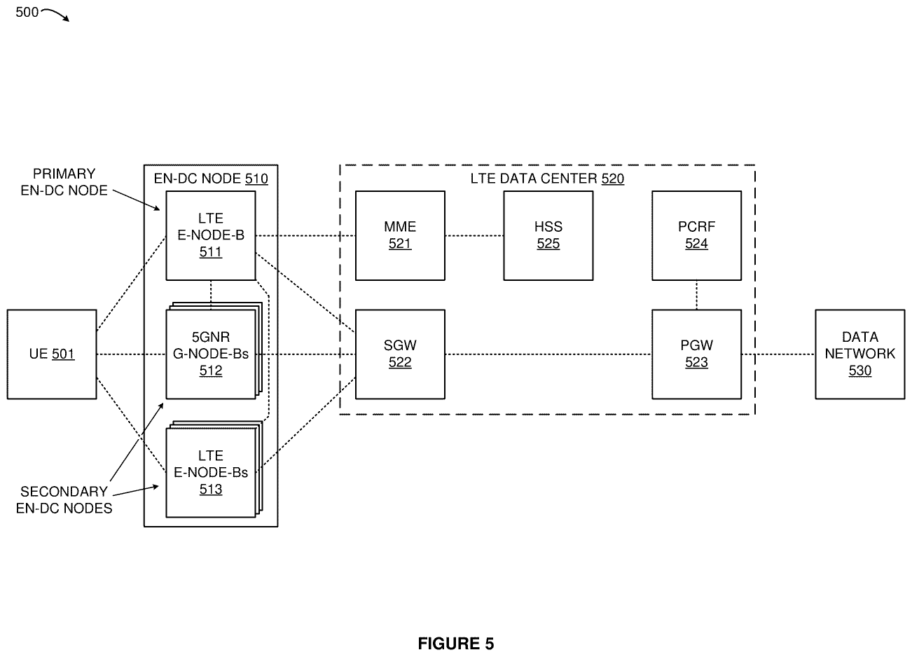

FIG. 5 illustrates 5G/LTE communication network 500 to manage secondary access node sleep mode. 5G/LTE communication network 500 comprises an example of communication network 100 illustrated in FIG. 1, however communication network 100 may differ. 5G/LTE communication network 500 comprises UE 501, EN-DC node 510, LTE data center 520, and data network 530. EN-DC node 510 comprises LTE eNodeB 511, 5GNR gNodeBs 512, and LTE eNodeBs 513. As illustrated in FIG. 5, LTE eNodeB 511 is the primary node in EN-DC node 510 while 5GNR gNodeBs 512 and LTE eNodeBs 513 are secondary nodes in EN-DC node 510. LTE data center 520 comprises MME 521, SGW 522, PGW 523, PCRF 524, and HSS 525. Other network functions and network entities like Home Subscriber Register (HLR) and Diameter Routing Agent (DRA) are typically present in LTE data center 520 but are omitted for clarity. In other examples, 5G/LTE communication network 500 may comprise different or additional elements than those illustrated in FIG. 5.

In some examples, LTE eNodeB 511 in EN-DC node 510 broadcasts System Information Blocks (SIBs). The SIBs identify LTE eNodeB 511 as well as the other nodes available in EN-DC node 510. UE 501 wirelessly receives the SIBs and measures signal metrics like RSRP and RSRQ of the SIBs. UE 501 attaches to LTE eNodeB 511 based on the signal metrics (e.g., when an RSRP/RSRQ threshold(s) is exceeded). UE 501 and LTE eNodeB 511 undergo a random access preamble process to establish a wireless connection between UE 501 and LTE eNodeB 511. Once the wireless connection is established, LTE eNodeB 511 establishes an RRC connection with UE 501 and UE 501 transfers a Packet Data Network (PDN) connectivity request to LTE eNodeB 511. LTE eNodeB 511 forwards the PDN connectivity request to MME 521. When UE 501 is a 5G capable UE, UE 501 indicates its 5G capability in the PDN connectivity request. In this example, UE 501 comprises 5G capabilities however in other examples, UE 501 may lack 5GNR capabilities.

MME 521 interacts with UE 501 over LTE eNodeB 511 and with HSS 525 to authenticate and authorize UE 501 for wireless data services that are represented by Access Point Names (APNs). In response to the authentication and authorization, MME 521 transfers the APNs and indicates the 5GNR capability for UE 501 to PGW 523 over SGW 522. PGW 523 interacts with PCRF 524 to select Quality-of-Service Class Identifiers (QCIs), network addresses, and 5GNR bitrates for UE 501 based on the APNs. PGW 523 indicates the APNs, QCIs, network addresses, and 5GNR bitrates for UE 501 to MME 521 over SGW 522. MME 521 transfers the APNs, QCIs, network address, and the 5GNR bitrates for UE 501 to LTE eNodeB 511. LTE eNodeB 511 transfers the selected APNs, QCIs, network addresses, and 5GNR bitrates to UE 501. PGW 523 exchanges user data for UE 501 with data network 530. PGW 523 exchanges the user data with SGW 522 which exchanges the user data with LTE eNodeB 511. LTE eNodeB 511 exchanges the user data with UE 501.

Secondary gNodeBs 512 broadcast 5GNR synchronization signals and secondary eNodeBs 513 broadcast SIBs. UE 501 wirelessly receives the 5GNR synchronization signals and LTE SIBs and measures the signal metrics like RSRP and RSRQ. UE 501 transfers a measurement report that characterizes the measured signal metrics to LTE eNodeB 511. LTE eNodeB 511 compares the throughput requirements for UE 501's PDN session to a throughput threshold to determine if a secondary cell(s) is needed. LTE eNodeB 511 compares the signal metrics for each secondary node to addition thresholds (e.g., B1 threshold, etc.). When the throughput and addition thresholds are met, LTE eNodeB 511 requests that the qualifying node(s) serve UE 501. In this example, LTE eNodeB 511 requests that one of 5GNR gNodeBs 512 serve UE 501, however in other examples, LTE eNodeB 511 may send requests to additional ones of 5GNR gNodeBs 512 and/or one or more of LTE eNodeBs 513 to serve UE 501. For example, UE 501 may be served by LTE eNodeB 511 and four secondary nodes from gNodeBs 512 and/or eNodeBs 513. The selected one of 5GNR gNodeBs 512 acknowledges the request and LTE eNodeB 511 transfers an RRC reconfiguration message to UE 501 to attach to the selected one of 5GNR gNodeBs 512. UE 501 attaches and LTE eNodeB 511 notifies MME 521. MME 521 directs SGW 522 to serve UE 501 over the one of 5GNR gNodeBs 512. In response, SGW 522 exchanges user data for UE 501 with the selected one of 5GNR gNodeB 512. The selected one of 5GNR gNodeB 512 exchanges the user data with UE 501. In some examples, SGW 522 instead exchanges the user data for UE 501 with LTE eNodeB 511 and LTE eNodeB 511 routes a portion of the user data to the selected one of 5GNR gNodeB 512.

As the selected one of 5GNR gNodeBs 512 serves UE 501, it monitors for sleep more triggers. The sleep mode triggers may comprise operator defined sleep schedules (e.g., maintenance schedules, nighttime, etc.) or can be triggered in response to network conditions (e.g., low-network use). When the selected one of 5GNR gNodeBs 512 detects a sleep mode trigger, it transfers a sleep mode request to LTE eNodeB 511. LTE eNodeB 511 approves the request and indicates the approval to the one of 5GNR gNodeBs 512. The one of 5GNR gNodeBs 512 enters sleep mode and stops serving UE 501. 5GNR gNodeBs 512 and LTE eNodeBs 513 may enter sleep mode for predefined time periods (e.g., eight hours) or may exit sleep mode based on network conditions (e.g., high-network usage). LTE eNodeB 511 transfers an RRC reconfiguration message to UE 501 to detach UE 501 from the one of 5GNR gNodeBs 512. UE 501 detaches and adds the one of 5GNR gNodeBs 512 to a blacklist to inhibit UE 501 from attempting to connect while the one of 5GNR gNodeBs 512 is in sleep mode.

Subsequently, the one of 5GNR gNodeBs 512 decides to exit sleep mode. The one of 5GNR gNodeBs 512 exits sleep mode in response to network conditions, network operator command, and/or after the expiration of the sleep mode time period. In response, the one of 5GNR gNodeBs 512 notifies LTE eNodeB 511 that it has exited sleep mode. LTE eNodeB 511 transfers an RRC reconfiguration message to UE 501 to reattach UE 501 to the one of 5GNR gNodeBs 512. UE 501 attaches and removes the one of 5GNR gNodeBs 512 from the blacklist to allow UE 501 to attempt to connect to the one of 5GNR gNodeBs 512. In examples where LTE eNodeB 511 selects one of more of LTE eNodeBs 513 to serve as secondary cells for UE 501, LTE eNodeB 511 and LTE eNodeBs 513 operate as described above with respect to the one of 5GNR gNodeBs 512 to manage secondary node sleep mode.

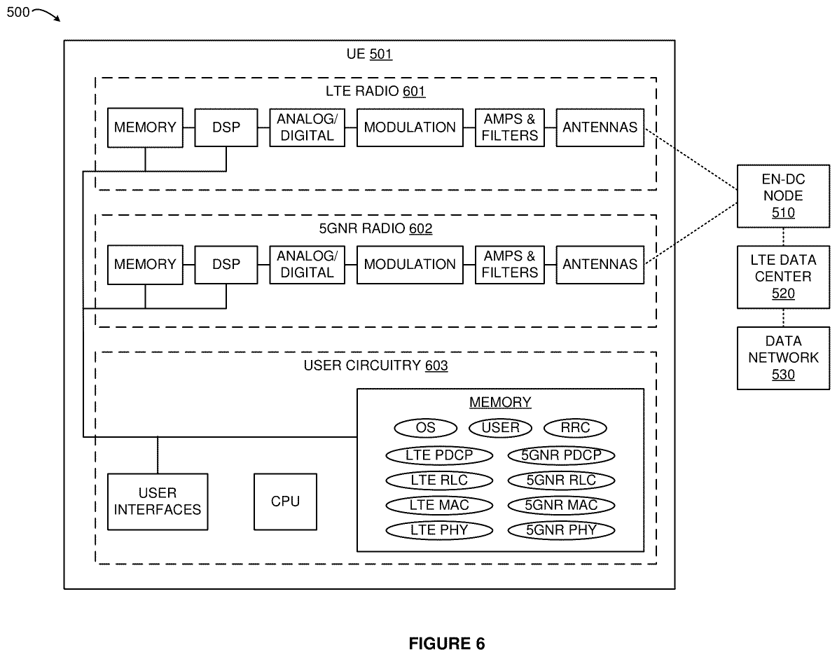

FIG. 6 illustrates UE 501 in 5G/LTE communication network 500. UE 501 comprises an example of user device 101 illustrated in FIG. 1, although user device 101 may differ. UE 501 comprises LTE radio 601, 5G radio 602, and user circuitry 603. LTE radio 601 comprises LTE antennas, amplifiers, filters, modulation, analog-to-digital interfaces, Digital Signal Processers (DSP), memory, and transceivers (XCVRs) that are coupled over bus circuitry. 5G radio 602 comprises 5GNR antennas, amplifiers, filters, modulation, analog-to-digital interfaces, DSP, memory, and transceivers that are coupled over bus circuitry. User circuitry 603 comprises memory, CPU, user interfaces and components, and transceivers that are coupled over bus circuitry.

The memory in user circuitry 603 stores an operating system (OS), user applications (USER), and network applications for RRC, LTE PDCP, LTE RLC, LTE MAC, LTE PHY, 5GNR PDCP, 5GNR RLC, 5GNR MAC, and 5GNR PHY. In some examples, the memory may also store a network application for 5GNR SDAP. The antenna in LTE radio 601 and 5G radio 602 are wirelessly coupled to EN-DC node 510 over an LTE link and 5GNR link respectively. Transceivers in radios 601 and 602 are coupled to a transceiver in user circuitry 603. A transceiver in user circuitry 603 is typically coupled to user interfaces and components like displays, controllers, and memory.

In LTE radio 601, the antennas receive wireless signals from EN-DC node 510 that transport downlink LTE signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding LTE symbols to user circuitry 603 over the transceivers. In user circuitry 603, the CPU executes the RRC and LTE network applications to process the LTE symbols and recover the downlink LTE signaling and data. The RRC and LTE network applications receive new uplink signaling and data from the user applications. The RRC and LTE network applications process the uplink user signaling and the downlink LTE signaling to generate new downlink user signaling and new uplink LTE signaling. The RRC and LTE network applications transfer the new downlink user signaling and data to the user applications. The RRC and LTE network applications process the new uplink LTE signaling and user data to generate corresponding uplink LTE symbols that carry the uplink LTE signaling and data.

In LTE radio 601, the DSP processes the uplink LTE symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless LTE signals to EN-DC node 510 that transport the uplink LTE signaling and data.

In 5G radio 602, the antennas receive wireless signals from EN-DC node 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 603 over the transceivers. In user circuitry 603, the CPU executes the RRC and 5GNR network applications to process the 5GNR symbols and recover the downlink 5GNR signaling and data. The RRC and 5GNR network applications receive new uplink signaling and data from the user applications. The RRC and 5GNR network applications process the uplink user signaling and the downlink 5GNR signaling to generate new downlink user signaling and new uplink 5GNR signaling. The RRC and 5GNR network applications transfer the new downlink user signaling and data to the user applications. The RRC and 5GNR network applications process the new uplink 5GNR signaling and user data to generate corresponding uplink 5GNR symbols that carry the uplink 5GNR signaling and data.

In 5G radio 602, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to EN-DC node 510 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

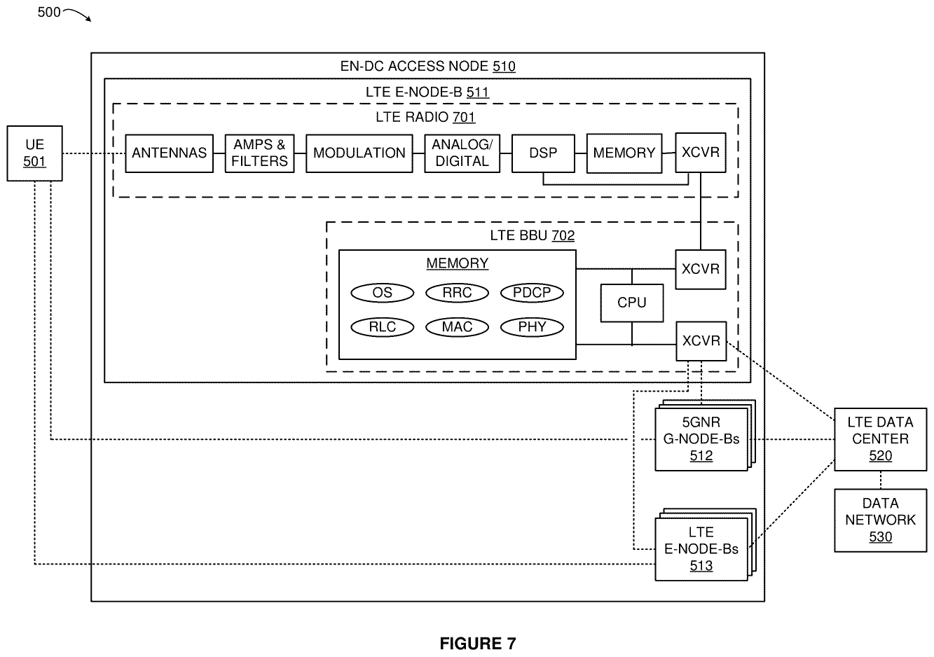

FIG. 7 illustrates LTE eNodeB 511 in EN-DC node 510 in 5G/LTE communication network 500. EN-DC node 510 comprises an example of primary access node 110 and secondary access node 120 illustrated in FIG. 1, however access nodes 110 and 120 may differ. LTE eNodeB 511 comprises an example of primary access node 110 illustrated in FIG. 1, although primary access nodes 110 may differ. Likewise, 5GNR gNodeBs 512 and LTE eNodeBs 513 comprise examples of secondary access node 120 illustrated in FIG. 1, however secondary access node 120 may differ. LTE eNodeBs 513 comprise a similar architecture to LTE eNodeB 511. However, secondary access nodes like 5GNR gNodeBs 512 and LTE eNodeBs 513 typically lack an RRC which is instead hosted by the primary access node. LTE eNodeB 511, 5GNR gNodeBs 512, and LTE eNodeBs 513 in EN-DC node 510 may be geographically distributed or co-located at a single site. LTE eNodeB 511 comprises LTE radio 701 and LTE BBU 702. LTE radio 701 comprises LTE antennas, amplifiers, filters, modulation, analog-to-digital interfaces, DSP, memory, and transceivers (XCVRs) that are coupled over bus circuitry. UE 501 is wirelessly coupled to antennas in LTE radio 701 over LTE links. Transceivers in LTE radio 701 are coupled to transceivers in LTE BBU 702 over fronthaul links like Common Public Radio Interface (CPRI). The DSPs in LTE radio 701 execute their operating systems and radio applications to exchange LTE signals with UE 501 and to exchange LTE data with LTE BBU 702.

For the uplink, the antennas in LTE radio 701 receive wireless signals from UE 501 that transport uplink LTE signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to LTE BBU 702 over the transceivers.

For the downlink, the DSPs receive downlink LTE symbols from LTE BBU 702. The DSPs process the downlink LTE symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink LTE signaling and data.

LTE BBU 702 comprises memory, CPU, and transceivers that are coupled over bus circuitry. The memory in LTE BBU 702 stores operating systems and LTE network applications like PHY, MAC, RLC, PDCP, and RRC. Transceivers in LTE BBU 702 are coupled to transceivers in LTE radio 701 over front-haul links. Transceivers in LTE BBU 702 are coupled to LTE data center 520 over backhaul links and to 5GNR gNodeBs 512 and LTE eNodeBs 513 over X2 links.

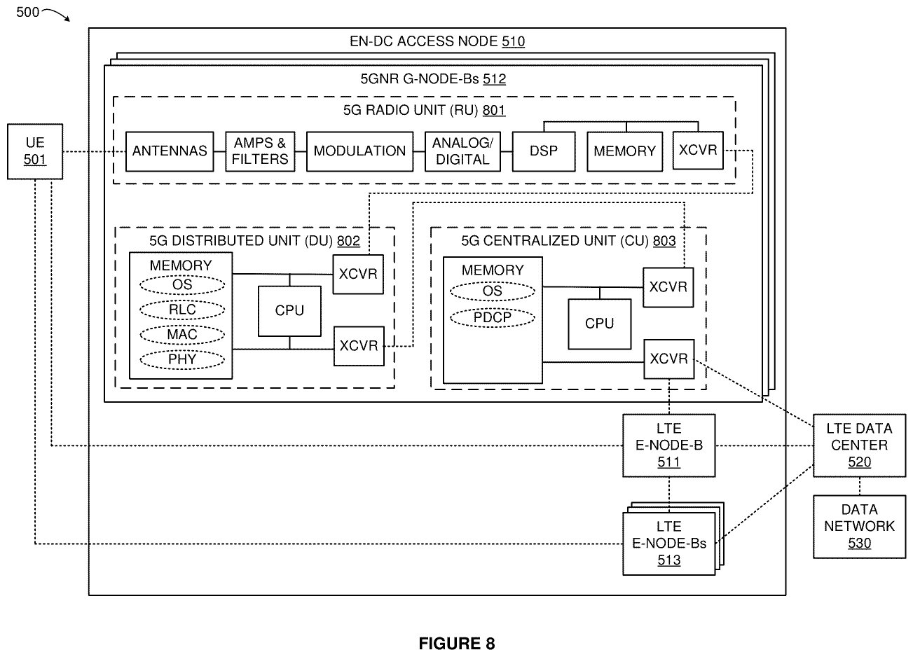

FIG. 8 illustrates 5GNR gNodeBs 512 in EN-DC node 510 in 5G/LTE communication network 500. 5GNR gNodeBs 512 comprise 5G RU 801, 5G DU 802, and 5G CU 803. RU 801 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 801 over 5GNR links. Transceivers in RU 801 are coupled to transceivers in DU 802 over fronthaul links like enhanced Common Public Radio Interface (eCPRI). The DSPs in RU 801 executes their operating systems and radio applications to exchange 5GNR signals with UE 501 and to exchange 5GNR data with DU 802.

For the uplink, the antennas in RU 801 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 802 over the transceivers.

For the downlink, the DSPs receive downlink 5GNR symbols from DU 802. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 802 comprises memory, CPU, and transceivers that are coupled over bus circuitry. The memory in DU 802 stores operating systems and 5GNR network applications like PHY, MAC, and RLC. CU 803 comprises memory, CPU, and transceivers that are coupled over bus circuitry. The memory in CU 803 stores an operating system and 5GNR network applications like PDCP. In some examples, the memory in CU 803 may also store an SDAP network application. In some examples, DU 802 and CU 803 are omitted and 5GNR gNodeBs 512 instead comprise BBUs similar to LTE eNodeBs 511 and 513. In some examples, LTE eNodeB 511, 5GNR gNodeBs 512, and LTE eNodeBs 513 may share a BBU or share a DU and CU. For example, 5G DU 802, 5G CU 803, and the BBUs in LTE eNodeBs 513 may be omitted and LTE radio 701, 5GNR RU 801, and the LTE radios in LTE eNodeBs 513 may be coupled to LTE BBU 702. In such examples, the shared BBU (or shared CU and DU) may host the LTE and 5GNR network applications to implement LTE eNodeB 511, 5GNR gNodeBs 512, and LTE eNodeBs 513 and provide the primary and secondary cells to UE 501.

Transceivers in DU 802 are coupled to transceivers in RU 801 over front-haul links. Transceivers in DU 802 are coupled to transceivers in CU 803 over mid-haul links. A transceiver in CU 803 is coupled to 5G network core 530 over backhaul links and to LTE eNodeB 511 over an X2 link.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

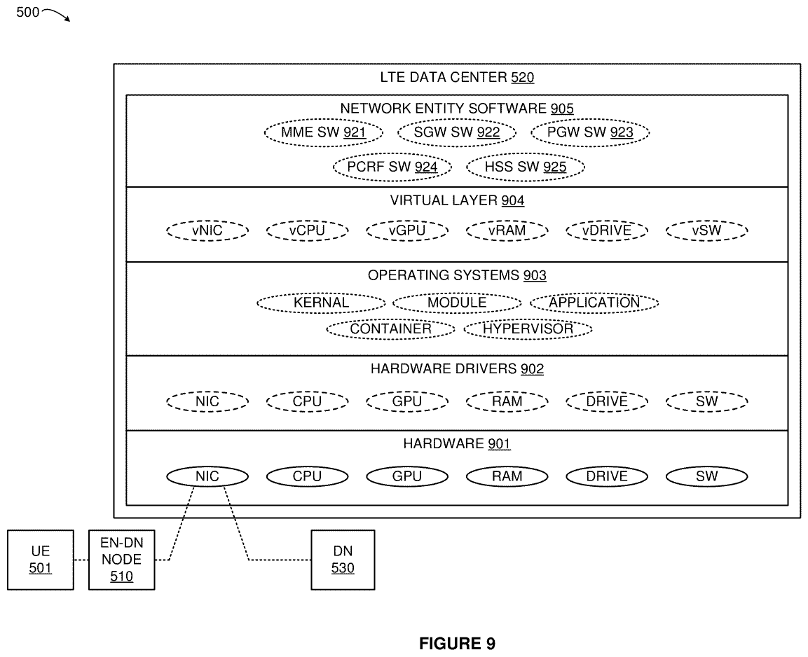

FIG. 9 illustrates LTE data center 520 in 5G/LTE communication network 500. LTE data center 520 comprises an example of core network 130 illustrated in FIG. 1, although core network 130 may differ. LTE data center 520 typically comprises a virtualized computing architecture like Network Function Virtualization Infrastructure (NFVI), but may comprise another computing architecture like a cloud computing network, a hybrid cloud network, and the like. LTE data center 520 comprises hardware 901, hardware drivers 902, operating systems 903, virtual layer 904, and network entity software 905. Hardware 901 comprises Network Interface Cards (NICs), CPU, GPU, RAM, Flash/Disk Drives (DRIVE), and Data Switches (SW). Hardware drivers 902 comprise software that is resident in the NIC, CPU, GPU, RAM, DRIVE, and SW. Operating systems 903 comprise kernels, modules, applications, containers, hypervisors, and the like. Virtual layer 904 comprises vNIC, vCPU, vGPU, vRAM, vDRIVE, and vSW. Network entity software 905 comprises MME software (SW) 921, SGW software 922, PGW software 923, PCRF software 924, and HSS software 925. Additional network entity software for HLR and DRA is typically present but is omitted for clarity. LTE data center 520 may be located at a single site or be distributed across multiple geographic locations. The NIC in hardware 901 is coupled to EN-DC node 510, data network 530, and to external systems (not illustrated). Hardware 901 executes hardware drivers 902, operating systems 903, virtual layer 904, and network entity software 905 to form MME 521, SGW 522, PGW 523, PCRF 524, and HSS 525.

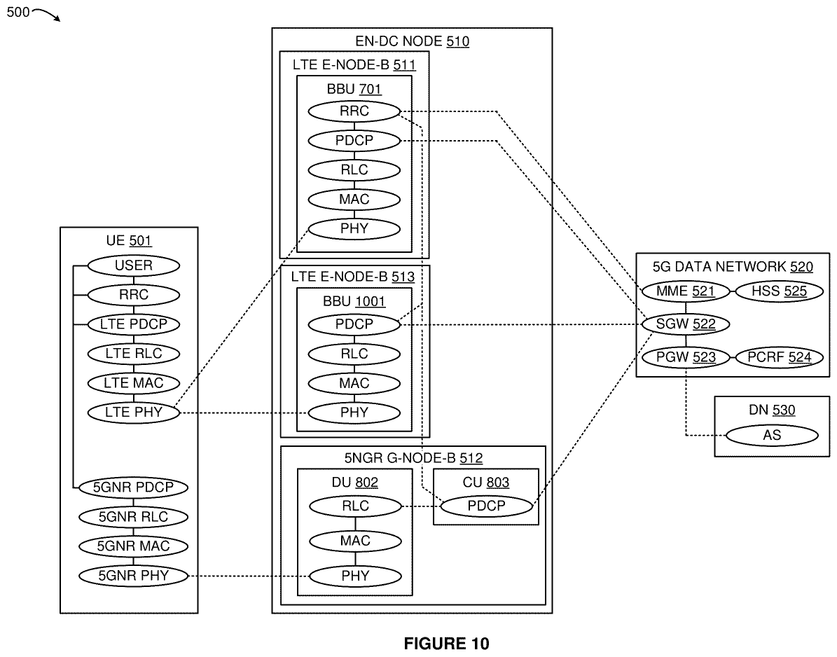

FIG. 10 illustrates an exemplary operation of 5G/LTE communication network 500 to manage secondary access node sleep mode. The exemplary operation comprises an example of processes 200, 300, and 400 illustrated in FIGS. 2, 3, and 4, however processes 200, 300, and 400 may differ. The exemplary operation may vary in other examples. In this example, 5GNR gNodeBs 512 and LTE eNodeBs 413 are referred to in the singular for sake of clarity. In some examples, the RRC in LTE eNodeB 511 controls the lower layer network applications to broadcast SIBs. The LTE PHY in UE 501 wirelessly receives the SIBs and measures RSRP and RSRQ. The LTE PHY reports the RSRP and RSRQ to the RRC in UE 501. The RRC decides to attach to LTE eNodeB 511 based on the RSRP and RSRQ. The RRCs in UE 501 and LTE eNodeB 511 interface over the PDCPs, RLCs, MACs, and PHYs to establish a wireless connection between UE 501 and LTE eNodeB 511. The RRC in UE 501 transfers a PDN connectivity request and indicates its 5GNR capability to the RRC in LTE eNodeB 511 over the PDCPs, RLCs, MACs, and PHYs. The RRC in LTE eNodeB 511 forwards the PDN request and indication to MME 521.

MME 521 interacts with HSS 525 to authenticate and authorize UE 501 for wireless data services. In response to the authentication and authorization, MME 521 transfers APNs that correspond to the authorized services of UE 501 and indicates the 5GNR capability for UE 501 to PGW 523 over SGW 522. PGW 523 interacts with PCRF 524 to select QCIs, network addresses, and 5GNR bitrates for UE 501 based on the APNs. PGW 523 indicates the APNs, QCIs, network addresses, and 5GNR bitrates for UE 501 to MME 521 over SGW 522. MME 521 transfers the APNs, QCIs, network address, and the 5GNR bitrates for UE 501 to the RRC in LTE eNodeB 511. The RRC in LTE eNodeB 511 transfers the received information to the RRC in UE 501 over the PDCPs, RLCs, MACs, and PHYs. PGW 523 exchanges user data for UE 501 with the AS in data network 530. PGW 523 exchanges the user data with SGW 522 which exchanges the user data with the PDCP in LTE eNodeB 511. The PDCP in LTE eNodeB 511 exchanges the user data with the PDCP in UE 501 over the RLCs, MACs, and PHYs.

5GNR gNodeB 512 broadcasts 5GNR synchronization signals and LTE eNodeB 513 broadcasts SIBs. The PHY in UE 501 wirelessly receives the 5GNR synchronization signals and LTE SIBs, measures RSRP and RSRQ, and reports the RSRQ and RSRP for the SIBs and synchronization signals to the RRC. The RRC in UE 501 transfers a measurement report that includes the RSRP and RSRQ for nodeBs 512 and 513 to the RRC in LTE eNodeB 511 over the PDCPs, RLCs, MACs, and PHYs. The RRC in LTE eNodeB 511 compares the throughput requirement of the PDN session to a throughput threshold and determines a secondary cell is needed. The RRC in LTE eNodeB 511 compares the RSRP and RSRQ for 5GNR gNodeB 512 to an addition threshold and determines 5GNR gNodeB 512's RSRP and RSRQ are insufficient. The RRC in LTE eNodeB 511 compares the RSRP and RSRQ for LTE eNodeB 513 to another addition threshold and determines LTE eNodeB 513's RSRP and RSRQ are sufficient. In response, the RRC in LTE eNodeB 511 directs LTE eNodeB 513 to serve UE 501 and transfers an RRC reconfiguration message to the RRC in UE 501 over the PDCPs, RLCs, MACs, and PHYs. The RRC in UE 501 controls the PDCP, RLC, MAC, and PHY in UE 501 to attach to LTE eNodeB 513 based on the RRC reconfiguration message. The RRC in LTE eNodeB 511 notifies MME 521 of the addition. MME 521 directs SGW 522 to serve UE 501 over LTE eNodeB 513. In response, SGW 522 exchanges user data for UE 501 with the PDCP in LTE eNodeB 513. The PDCP in LTE eNodeB 513 exchanges the user data with the PDCP in UE 501 over the RLCs, MACs, and PHYs.

LTE eNodeB 513 monitors the time to detect when a scheduled maintenance period occurs. When the maintenance period starts, LTE eNodeB 513 transfers a sleep mode request to the RRC in LTE eNodeB 511. The RRC in LTE eNodeB 511 approves the request and indicates the approval to LTE eNodeB 513. LTE eNodeB 513 enters sleep mode. The RRC in LTE eNodeB 511 notifies MME 521 and transfers an RRC reconfiguration message to the RRC in UE 501 over the PDCPs, RLCs, MACs, and PHYs. The RRC in UE 501 controls the PDCP, RLC, MAC, and PHY in UE 501 to detach from LTE eNodeB 513 based on the RRC reconfiguration message. The RRC in UE 501 blacklists LTE eNodeB 513 to inhibit UE 501 from attempting to connect while LTE eNodeB 513 is in sleep mode. MME 521 directs SGW 522 to stop serving UE 501 over LTE eNodeB 513. SGW 522 stops exchanging user data for UE 501 with the PDCP in LTE eNodeB 513 and the PDCP in LTE eNodeB 513 stops exchanging the user data with the PDCP in UE 501 over the RLCs, MACs, and PHYs.

Subsequently, LTE eNodeB 513 detects that the maintenance period is over and exits sleep mode. LTE eNodeB 513 notifies the RRC in LTE eNodeB 511 that it has exited sleep mode. The RRC in LTE eNodeB 511 transfers an RRC reconfiguration message to the RRC in UE 501 over the PDCPs, RLCs, MACs, and PHYs. The RRC in UE 501 controls the PDCP, RLC, MAC, and PHY to reattach to LTE eNodeB 513. The RRC in UE 501 removes LTE eNodeB 513 from the blacklist. The RRC in LTE eNodeB 511 notifies MME 521. MME 521 directs SGW 522 to resume serving UE 501 over LTE eNodeB 513. SGW 522 resumes exchanging user data for UE 501 with the PDCP in LTE eNodeB 513 and the PDCP in LTE eNodeB 513 resumes exchanging the user data with the PDCP in UE 501 over the RLCs, MACs, and PHYs.

The wireless data network circuitry described above comprises computer hardware and software that form special-purpose network circuitry to manage secondary access node sleep mode. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to manage secondary access node sleep mode.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
serving, by a primary access node, a wireless user device and directing a secondary access node to serve the wireless user device;
entering, by the secondary access node, a sleep mode, wherein the secondary access node ceases providing wireless service while in the sleep mode;
notifying, by the secondary access node, the primary access node that the secondary access node is entering the sleep mode;
wirelessly transferring, by the primary access node, a remove command to the wireless user device that directs the wireless user device to terminate its connection with the secondary access node;
exiting, by the secondary access node, the sleep mode;
notifying, by the secondary access node, the primary access node that the secondary access node is exiting the sleep mode; and
wirelessly transferring, by the primary access node, an add command to the wireless user device that directs the wireless user device to connect to the secondary access node.

2. The method of claim 1 further comprising:
detecting, by the secondary access node, a sleep mode requirement;
transferring, by the secondary access node; a sleep mode request to the primary access node;
approving, by the primary access node, the sleep mode request; and
transferring, by the primary access node, a sleep mode authorization to the secondary access node; and wherein:
entering, by the secondary access node, the sleep mode comprises entering the sleep mode in response to the sleep mode authorization.

3. The method of claim 2 wherein the sleep mode requirement comprises one or more of a time period, a maintenance period, a low usage period, or an energy saving period.

4. The method of claim 1 wherein:
wirelessly transferring, by the primary access node, the remove command to the wireless user device comprises wirelessly transferring a first Radio Resource Control (RRC) reconfiguration message to the wireless user device that directs the wireless user device to terminate its connection with the secondary access node; and
wirelessly transferring, by the primary access node, the add command to the wireless user device comprises transferring a second RRC reconfiguration message that directs the wireless user device to connect to the secondary access node.

5. The method of claim 1 wherein the primary access node and the secondary access node compose an Evolved Universal Terrestrial Radio Access Network Dual Connectivity (EN-DC) access node.

6. The method of claim 1 wherein the primary access node comprises a Long Term Evolution (LTE) Evolved NodeB (eNodeB).

7. The method of claim 1 wherein the secondary access node comprises at least one of a Long Term Evolution (LTE) Evolved NodeB (eNodeB) or a Fifth Generation New Radio (5GNR) Generational NodeB (gNodeB).

8. A system comprising:
a primary access node configured to:
serve a wireless user device; and
direct a secondary access node to serve the wireless user device;
the secondary access node configured to:
enter a sleep mode, wherein the secondary access node ceases providing wireless service while in the sleep mode; and
notify the primary access node that the secondary access node is entering the sleep mode;
the primary access node further configured to:
wirelessly transfer a remove command to the wireless user device that directs the wireless user device to terminate its connection with the secondary access node;
the secondary access node further configured to:
exit the sleep mode; and
notify the primary access node that the secondary access node is exiting the sleep mode; and
the primary access node further configured to:
wirelessly transfer an add command to the wireless user device that directs the wireless user device to connect to the secondary access node.

9. The system of claim 8 wherein:
the secondary access node is further configured to:
detect a sleep mode requirement; and
transfer a sleep mode request to the primary access node;
the primary access node is further configured to:
approve the sleep mode request; and
transfer a sleep mode authorization to the secondary access node; and
the secondary access node is further configured to:
enter the sleep mode in response to the sleep mode authorization.

10. The system of claim 9 wherein the sleep mode requirement comprises one or more of a time period, a maintenance period, a low usage period, or an energy saving period.

11. The system of claim 8 wherein:
the remove command comprises a first Radio Resource Control (RRC) reconfiguration message that directs the wireless user device to terminate its connection with the secondary access node; and
the add command comprises a second RRC reconfiguration message that directs the wireless user device to connect to the secondary access node.

12. The system of claim 8 further comprising an Evolved Universal Terrestrial Radio Access Network Dual Connectivity (EN-DC) access node; and wherein:
the EN-DC access node comprises the primary access node and the secondary access node.

13. The system of claim 8 wherein the primary access node comprises a Long Term Evolution (LTE) Evolved NodeB (eNodeB).

14. The system of claim 8 wherein the secondary access node comprises at least one of a Long Term Evolution (LTE) Evolved NodeB (eNodeB) or a Fifth Generation New Radio (5GNR) Generational NodeB (gNodeB).

15. One or more non-transitory computer readable storage media having program instructions stored thereon, wherein the program instruction, when executed by a computing system, direct the computing system to perform operations, the operations comprising:
controlling a radio to serve a wireless user device;
directing a secondary access node to serve the wireless user device;
receiving a sleep mode enter indication generated by the secondary access node, wherein the secondary access node ceases providing wireless service while in a sleep mode;
generating a remove command that directs the wireless user device to terminate its connection with the secondary access node;
directing the radio to wirelessly transfer the remove command to the wireless user device;
receiving a sleep mode exit indication generated by the secondary access node;
generating an add command that directs the wireless user device to connect to the secondary access node; and
directing the radio to wirelessly transfer the add command to the wireless user device.

16. The one or more non-transitory computer readable storage media 15 wherein receiving the sleep mode enter indication generated by the secondary access node comprises receiving the sleep mode enter indication generated by the secondary access node in response to the secondary access node detecting a sleep mode requirement.

17. The one or more non-transitory computer readable storage media 16 wherein the sleep mode requirement comprises one or more of a time period, a maintenance period, a low usage period, or an energy saving period.

18. The one or more non-transitory computer readable storage media 15 wherein:
generating the remove command comprises generating a first Radio Resource Control (RRC) reconfiguration message that directs the wireless user device to terminate its connection with the secondary access node;
directing the radio to wirelessly transfer the remove command to the wireless user device comprises directing the radio to wirelessly transfer the first RRC reconfiguration message to the wireless user device;
generating the add command comprises generating a second RRC reconfiguration message that directs the wireless user device to connect to the secondary access node; and
directing the radio to wirelessly transfer the add command to the wireless user device comprises directing the radio to wirelessly transfer the second RRC reconfiguration message to the wireless user device.

19. The one or more non-transitory computer readable storage media 15 wherein the secondary access node comprises at least one of a Long Term Evolution (LTE) Evolved NodeB (eNodeB) or a Fifth Generation New Radio (5GNR) Generational NodeB (gNodeB).

20. The one or more non-transitory computer readable storage media 15 wherein the secondary access node comprises a secondary access node of an Evolved Universal Terrestrial Radio Access Network Dual Connectivity (EN-DC) access node.
